(19) United States
(12) Patent Application Publication
(10) Pub. No.: US 2025/0053948 A1
(43) Pub. Date: Feb. 13, 2025

(54) SETTLEMENT SYSTEM, RECEIPT SYSTEM, AND METHOD OF CONTROLLING RECEIPT SYSTEM

(71) Applicant: SEIKO EPSON CORPORATION, Tokyo (JP)

(72) Inventors: Tsutomu KASAI, SHIMOSUWA-MACHI (JP); Tomohito SOMEYA, SHIOJIRI-SHI (JP); Shin KITAZAWA, SHIOJIRI-SHI (JP)

(21) Appl. No.: 18/797,156

(22) Filed: Aug. 7, 2024

(30) Foreign Application Priority Data
Aug. 8, 2023 (JP) 2023-129061

(51) Int. Cl. G06Q 20/20

(52) U.S. Cl. CPC G06Q 20/209

(57) ABSTRACT

A settlement system is a settlement system including a receipt printer, an information processing device, a first terminal device, a second terminal device, and a third terminal device. The first terminal device generates printing data and transmits the printing data to the receipt printer. The receipt printer transmits the received printing data to the information processing device. The information processing device generates image data based on the received printing data and transmits the image data to the second terminal device. The second terminal device displays the received image data and transmits first selection information to the information processing device when an electronic receipt has been selected. The information processing device determines, based on the received first selection information, that the electronic receipt has been selected and generates electronic receipt information and transmits the electronic receipt information when receiving an electronic receipt request from the third terminal device.

The present application is based on, and claims priority from JP Application Serial Number 2023-129061, filed Aug. 8, 2023, the disclosure of which is hereby incorporated by reference herein in its entirety.

### BACKGROUND

### 1. Technical Field

The present disclosure relates to a settlement system, a receipt system, and a method of controlling the receipt system.

### 2. Related Art

As disclosed in JP-A-2011-90375, there has been known a system that outputs a paper receipt or an electronic receipt based on information indicating necessity of output of a paper receipt set in advance for each customer indicated by identification information.

JP-A-2011-90375 is an example of the related art.

In the system explained above, since the paper receipt or the electronic receipt is output according to a result registered in advance for each customer, convenience has been low.

### SUMMARY

A settlement system is a settlement system including: a receipt printer including a fourth control unit; an information processing device including a fifth control unit; a first terminal device including a first control unit; a second terminal device including a second control unit; and a third terminal device including a third control unit, wherein the first control unit of the first terminal device generates printing data and transmits the printing data to the receipt printer, the fourth control unit of the receipt printer transmits the received printing data to the information processing device, the fifth control unit of the information processing device generates image data based on the received printing data and transmits the image data to the second terminal device, the second control unit of the second terminal device displays the received image data and transmits first selection information to the information processing device when an electronic receipt was selected, and the fifth control unit of the information processing device determines, based on the received first selection information, that the electronic receipt was selected and generates electronic receipt information and transmits the electronic receipt information when receiving an electronic receipt request from the third terminal device.

A settlement system is a settlement including: a receipt printer including a fourth control unit; an information processing device including a fifth control unit; a first terminal device including a first control unit; a second terminal device including a second control unit; and a third terminal device including a third control unit, wherein the first control unit of the first terminal device acquires customer identification information and transmits the customer identification information to the receipt printer, the fourth control unit of the receipt printer transmits the received customer identification information to the information processing device, the fifth control unit of the information processing device determines, based on the received customer identification information, that an electronic receipt was selected, the first control unit of the first terminal device generates printing data and transmits the printing data to the receipt printer, the fourth control unit of the receipt printer transmits the received printing data to the information processing device, and the fifth control unit of the information processing device generates electronic receipt information based on the received printing data and transmits the electronic receipt information when receiving an electronic receipt request from the third terminal device.

A receipt system is a receipt system including: a receipt printer including a fourth control unit; and an information processing device including a fifth control unit, wherein the receipt printer is capable of communicating with the information processing device and a first terminal device, the information processing device is capable of communicating with the receipt printer, a second terminal device, and a third terminal device, the fourth control unit of the receipt printer receives printing data from the first terminal device and transmits the printing data to the information processing device, and the fifth control unit of the information processing device generates image data based on the received printing data and transmits the image data to the second terminal device and, when receiving first selection information from the second terminal device, determines, based on the first selection information, that an electronic receipt was selected and generates electronic receipt information and transmits the electronic receipt information when receiving an electronic receipt request from the third terminal device.

A method for controlling a receipt system including a receipt printer and an information processing device, wherein the receipt printer is capable of communicating with the information processing device and a first terminal device, the information processing device is capable of communicating with the receipt printer, a second terminal device, and a third terminal device, the receipt printer receives printing data from the first terminal device and transmits the printing data to the information processing device, and the information processing device generates image data based on the received printing data and transmits the image data to the second terminal device and, when receiving first selection information from the second terminal device, determines, based on the first selection information, that an electronic receipt was selected and generates electronic receipt information and transmits the electronic receipt information when receiving an electronic receipt request from the third terminal device.

### BRIEF DESCRIPTION OF THE DRAWINGS

FIG. 1 is a block diagram illustrating configurations of a receipt system including a receipt printer and an information processing device and a POS system including the receipt system, a POS terminal device, a store terminal device, and a customer terminal device.

FIG. 2 is a state transition diagram at the time when the information processing device determines, based on selection of an electronic receipt by the store terminal device, that the electronic receipt has been selected, generates the electronic receipt based on printing data received from the receipt printer, and transmits the electronic receipt when receiving the electronic receipt request from the customer terminal device.

FIG. 3 is a state transition diagram at the time when the information processing device determines, based on selection of a paper receipt by the store terminal device, that the paper receipt has been selected, transmits a printing request to the receipt printer, and causes the receipt printer to print the paper receipt.

FIG. 4 is a state transition diagram at the time when the information processing device determines, based on an ID received from the receipt printer, that an electronic receipt has been selected, generates the electronic receipt based on printing data received from the receipt printer, and transmits the electronic receipt when receiving an electronic receipt request from the customer terminal device.

### DESCRIPTION OF EMBODIMENTS

### 1. Configuration of a Settlement System Including a Receipt System

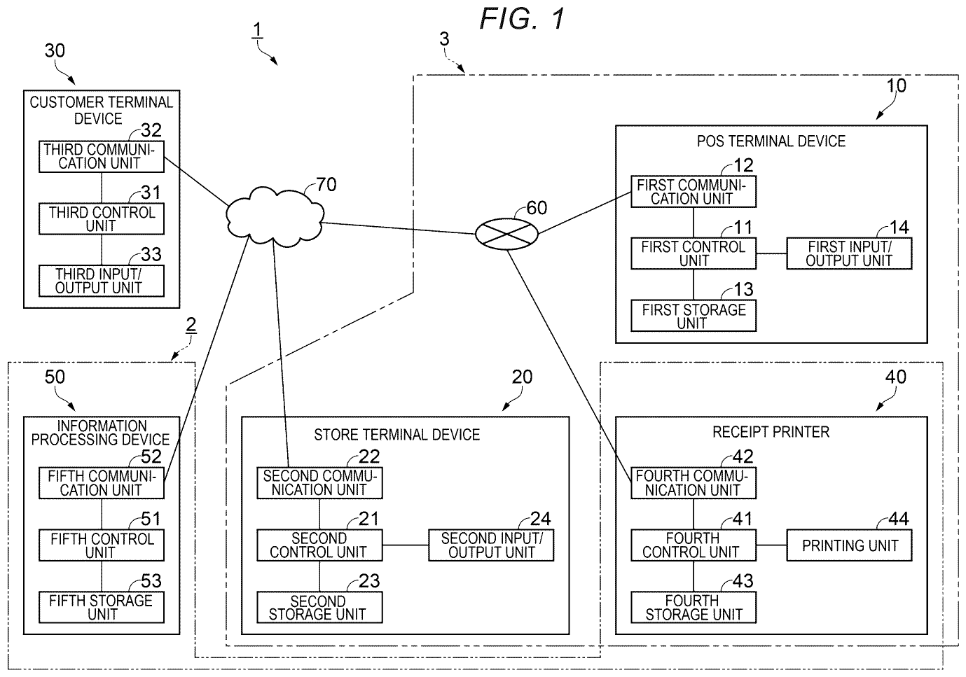

FIG. 1 illustrates a configuration of a POS system 1 that is a settlement system including a POS (Point Of Sale) terminal device 10 that is a first terminal device, a store terminal device 20 that is a second terminal device, a receipt printer 40, an information processing device 50, and a customer terminal device 30 that is a third terminal device. The receipt printer 40 and information processing device 50 configure a receipt system 2.

For example, the store terminal device 20 is a so-called kiosk terminal used in a store. The customer terminal device 30 is a portable terminal of a customer such as a smartphone. The information processing device 50 is a server.

The POS terminal device 10, the store terminal device 20, and the receipt printer 40 are installed in a premise 3 such as a store.

The POS terminal device 10 and the receipt printer 40 are capable of communicating with each other via a LAN (Local Area Network) 60. The store terminal device 20, the customer terminal device 30, the information processing device 50, and the LAN 60 are capable of communicating with one another via a WAN (Wide Area Network) 70.

The LAN 60 includes a router and a firewall and includes a function of enabling communication between the LAN 60 and the WAN 70.

The devices configuring the POS system 1 are respectively assigned with, for example, unique IP addresses (Internet Protocol Addresses). The devices can designate an IP address assigned to a communication destination and communicate with the communication destination.

The POS terminal device 10 includes a first control unit 11, a first communication unit 12, a first storage unit 13, and a first input/output unit 14.

The first control unit 11 collectively controls the units of the POS terminal device 10. The first control unit 11 includes a CPU (Central Processing Unit). The CPU is also referred to as processor.

The first storage unit 13 includes a flash ROM (Read Only Memory), which is a rewritable nonvolatile memory, and a RAM (Random Access Memory), which is a volatile memory.

The first control unit 11 reads a program stored in the flash ROM of the first storage unit 13 and executes respective kinds of processing using the RAM of the first storage unit 13 as a work area.

The first communication unit 12 of the POS terminal device 10 includes a circuit that is capable of communicating with a communication destination by radio or The first communication unit 12 includes an by wire. antenna in the case of radio and includes a connector in the case of wire.

When performing transmission and reception to and from the communication destination, the POS terminal device 10 performs the transmission and reception through the first communication unit 12. However, in the following explanation, in order to simplify the explanation, the transmission and reception by the first communication unit 12 is omitted. The first communication unit 12 communicates with the receipt printer 40 via the LAN 60. However, in the following explanation, the communication via the LAN 60 is omitted below.

The first input/output unit 14 of the POS terminal device 10 is, for example, a touch panel display. The first input/output unit 14 includes a display panel that is an output unit that displays various kinds of information and a detection panel that is an input unit. The input unit may include a keyboard or a mouse. The output unit may be a stand type liquid crystal display or the like.

The input unit of the first input/output unit 14 includes a reader and is capable of reading information of an IC, a two-dimensional code, or the like carried by the customer terminal device 30 or a card of the customer.

The reader of the input unit of the first input/output unit 14 is capable of reading a barcode of a commodity. The first control unit 11 generates settlement information based on the barcode read by the reader. The first control unit 11 generates printing data based on the settlement information and transmits the printing data to the receipt printer 40.

The POS terminal device 10 may include a so-called automatic change machine including functions of depositing and dispensing cash.

The store terminal device 20 includes a second control unit 21, a second communication unit 22, a second storage unit 23, and a second input/output unit 24. These components of the store terminal device 20 are substantially the same as the components of the POS terminal device 10 explained above. Therefore, explanation of the components is omitted.

The second input/output unit 24 of the store terminal device 20 is a user interface for the customer.

When performing transmission and reception to and from a communication destination, the store terminal device 20 performs the transmission and reception through the second communication unit 22. However, in the following explanation, in order to simplify the explanation, the transmission and reception by the second communication unit 22 is omitted. The second communication unit 22 communicates with the information processing device 50 via the WAN 70. However, in the following explanation, the communication via the WAN 70 is omitted.

The customer terminal device 30 includes a third control unit 31, a third communication unit 32, and a third input/output unit 33. These components of the customer terminal device 30 are substantially the same as the components of the POS terminal device 10 explained above. Therefore, explanation of the components is omitted.

When performing transmission and reception to and from a communication destination, the customer terminal device 30 performs the transmission and reception through the third communication unit 32. However, in the following explanation, in order to simplify the explanation, the transmission and reception by the third communication unit 32 is omitted. The third communication unit 32 communicates with the information processing device 50 via the WAN 70. However, in the following explanation, the communication via the WAN 70 is omitted.

The information processing device 50 includes a fifth control unit 51, a fifth communication unit 52, and a fifth storage unit 53. These components of the information processing device 50 are substantially the same as the components of the POS terminal device 10 explained above. Therefore, explanation of the components is omitted. The nonvolatile memory of the fifth storage unit 53 may include an SSD (Solid State Drive) or a HDD (hard disk).

When performing transmission and reception to and from a communication destination, the information processing device 50 performs the transmission and reception through the fifth communication unit 52. However, in the following explanation, in order to simplify the explanation, the transmission and reception by the fifth communication unit 52 is omitted. The fifth communication unit 52 communicates with the store terminal device 20 and the customer terminal device 30 via the WAN 70. However, in the following explanation, the communication via the WAN 70 is omitted. The fifth communication unit 52 communicates with the receipt printer 40 via the WAN 70 and LAN 60. However, in the following explanation, the communication via the LAN 60 and WAN 70 is also omitted.

The receipt printer 40 includes a printing unit 44 including a head for printing on paper and a conveyance mechanism for conveying the paper. For example, the head is of a thermal type or an inkjet type.

The receipt printer 40 further includes a fourth control unit 41, a fourth communication unit 42, and a fourth storage unit 43. These components of the receipt printer 40 are substantially the same as the components of the POS terminal device 10 explained above. Therefore, explanation of the components is omitted.

The receipt printer 40 is capable of communicating with the POS terminal device 10 via the LAN 60 through the fourth communication unit 42. The fourth communication unit 42 of the receipt printer 40 is capable of communicating with the information processing device 50 as well via the LAN 60 and WAN 70.

When performing transmission and reception to and from a communication destination, the receipt printer 40 performs the transmission and reception through the fourth communication unit 42. However, in the following explanation, in order to simplify the explanation, the transmission and reception by the fourth communication unit 42 is omitted. The fourth communication unit 42 is capable of communicating with the information processing device 50 via the LAN 60 and the WAN 70. However, in the following explanation, the communication via the LAN 60 and the WAN 70 is omitted.

### 2. Method of Controlling the Settlement System and the Receipt System When an Electronic Receipt Is Output

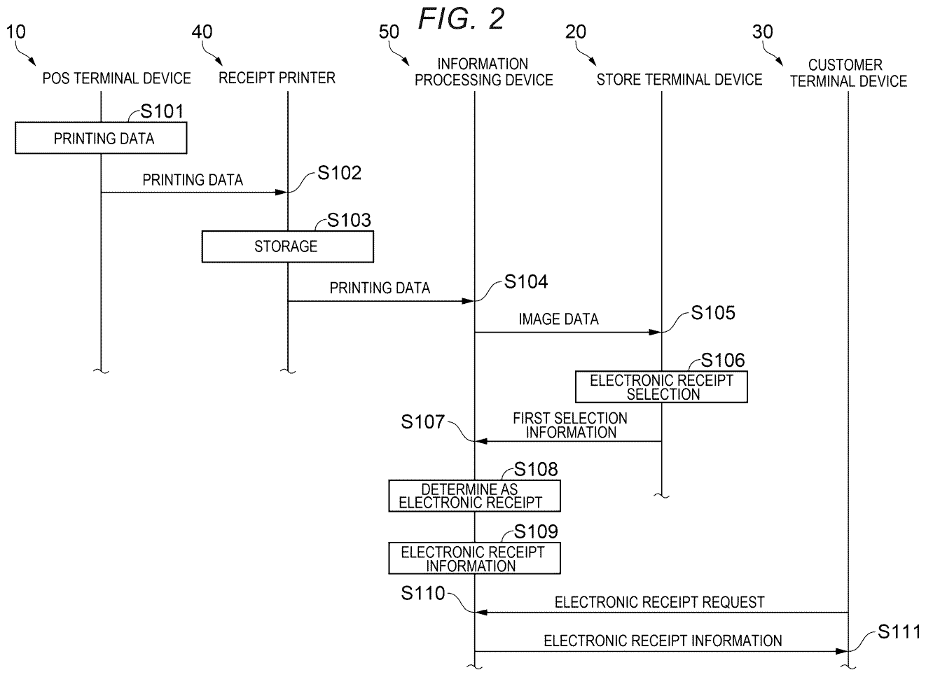

A method of controlling the settlement system and the receipt system in which the information processing device 50 determines, based on selection of the customer for the store terminal device 20, that an electronic receipt has been selected and outputs the electronic receipt is explained with reference to FIG. 2.

The first control unit 11 of the POS terminal device 10 generates, based on a barcode read by the reader of the first input/output unit 14, settlement information including a price and a total amount of a commodity. The first control unit 11 generates printing data based on the settlement information (S101) and transmits the printing data to the receipt printer 40 (S102). The printing data includes text data such as an ASCII code.

When receiving the printing data from the POS terminal device 10, the fourth control unit 41 of the receipt printer 40 stores the printing data in the fourth storage unit 43 (S103). The receipt printer 40 is capable of printing the printing data but does not print the printing data at this timing and suspends execution of the printing. As explained below, the receipt printer 40 does not print the printing data until a printing request is received from the information processing device 50. The fourth control unit 41 transmits the printing data to the information processing device 50 (S104).

The fifth control unit 51 of the information processing device 50 generates image data based on the printing data received from the receipt printer 40 and transmits the image data to the store terminal device 20 (S105). The image data is image data capable of displaying, on a liquid crystal display of the second input/output unit 24 of the store terminal device 20, an image at the time when the printing data is printed on paper by the receipt printer 40.

Font data, which is image data, corresponding to the text data is stored in the fifth storage unit 53. The fifth control unit 51 can read the font data corresponding to the text data of the printing data from the fifth storage unit 53 and generate image data.

The printing data is stored in the fifth storage unit 53. As explained below, the printing data is used when the fifth control unit 51 generates the electronic receipt information.

The second control unit 21 of the store terminal device 20 displays, with the second input/output unit 24, the image data received from the information processing device 50. The second control unit 21 also displays, with the second input/output unit 24, together with the image data, buttons for causing the customer to select a paper receipt or an electronic receipt.

The customer selects and operates a button for the paper receipt or the electronic receipt. The second control unit 21 detects that the button for the paper receipt or the electronic receipt has been selected by the second input/output unit 24. Here, it is assumed that the second control unit 21 detects that the electronic receipt has been selected (S106).

The second control unit 21 transmits first selection information, which is information indicating that the electronic receipt has been selected, to the information processing device 50 (S107).

The fifth control unit 51 of the information processing device 50 determines, based on the first selection information received from the store terminal device 20, that a form of outputting settlement information to the customer is the electronic receipt (S108).

The fifth control unit 51 reads the printing data stored in the fifth storage unit 53 and generates electronic receipt information (S109). The electronic receipt information is stored in the fifth storage unit 53.

The electronic receipt information is image data capable of displaying, on a liquid crystal display or the like of the third input/output unit 33 of the customer terminal device 30, an image at the time when printing data is printed on paper by the receipt printer 40. The fifth control unit 51 can generate the electronic receipt information based on the printing data like the image data explained above. The electronic receipt information may be the same as the image data explained above.

When desiring to check the settlement information with the electronic receipt, the customer performs predetermined operation on the third input/output unit 33 of the customer terminal device 30.

The third control unit 31 of the customer terminal device 30 generates, based on the predetermined operation on the third input/output unit 33 by the customer, an electronic receipt request and transmits the electronic receipt request to the information processing device 50 (S110).

When receiving the electronic receipt request from the customer terminal device 30, the fifth control unit 51 of the information processing device 50 reads the electronic receipt information from the fifth storage unit 53 and transmits the electronic receipt information to the customer terminal device 30 (S111). The information processing device 50 transmitting the electronic receipt information is also referred to as outputting the electronic receipt.

The third control unit 31 of the customer terminal device 30 can display, with the third input/output unit 33, the electronic receipt information received from the information processing device 50.

That is, the information processing device 50 can output the settlement information in a form of an electronic receipt with the customer terminal device 30 based on the selection of the electronic receipt of the customer for the store terminal device 20. The customer can check the settlement information with the electronic receipt output to the customer terminal device 30.

Note that the printing data stored in the fourth storage unit 43 of the receipt printer 40 is erased in order from oldest printing data when an available capacity of the fourth storage unit 43 runs short when the next printing data is received. The printing data stored in the fourth storage unit 43 may be erased at timing of receiving the next printing data. The printing data and the like stored in the fifth storage unit 53 of the information processing device 50 are also erased at the same timing.

### 3. Method of Controlling the Settlement System and the Receipt System When a Paper Receipt Is Output

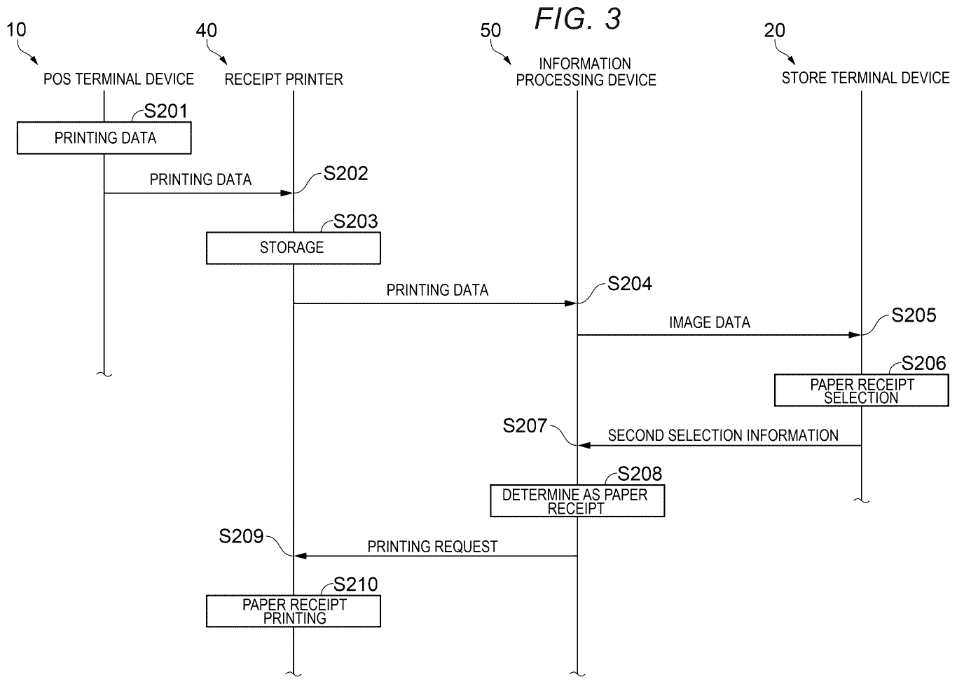

A method of controlling the settlement system and the receipt system in which the information processing device 50 determines, based on selection of the customer for the store terminal device 20, that a paper receipt has been selected and outputs the paper receipt with the receipt printer 40 is explained with reference to FIG. 3.

Processing from when the POS terminal device 10 generates printing data (S201) to when the store terminal device 20 receives (S205) and displays the image data is the same as the processing in the case of FIG. 2 explained above. Therefore, explanation of the processing is omitted. The processing in (S201) to (S205) illustrated in FIG. 3 corresponds to the processing from (S101) to (S105) illustrated in FIG. 2.

Here, it is assumed that the customer selects and operates the button for the paper receipt on the store terminal device 20. The second control unit 21 of the store terminal device 20 detects that not the electronic receipt but the paper receipt has been selected by the second input/output unit 24 (S206).

The second control unit 21 transmits second selection information, which is information indicating that the paper receipt has been selected and is different from the first selection information, to the information processing device 50 (S207).

The fifth control unit 51 of the information processing device 50 determines, based on the second selection information received from the store terminal device 20, that a form of outputting the settlement information to the customer is the paper receipt (S208). The fifth control unit 51 transmits a printing request to the receipt printer 40 (S209).

When receiving the printing request from the information processing device 50, the fourth control unit 41 of the receipt printer 40 reads the printing data from the fourth storage unit 43 and prints the paper receipt with the printing unit 44 (S210). Note that the information processing device 50 causing the receipt printer 40 to print the paper receipt is also referred to as outputting the paper receipt.

That is, the information processing device 50 can output the settlement information in the form of the paper receipt with the receipt printer 40 based on the selection of the paper receipt by the customer for the store terminal device 20. The customer can check the settlement information with the paper receipt output from the receipt printer 40.

The printing data temporarily stored in the fourth storage unit 43 of the receipt printer 40 is erased after the paper receipt is output. The printing data may be erased in order from the oldest printing data when an available capacity of the fourth storage unit 43 runs short when the next printing data is received. The printing data stored in the fourth storage unit 43 may be erased at timing of receiving the next printing data. The printing data and the like stored in the fifth storage unit 53 of the information processing device 50 are also erased at the same timing.

### 4. Method of Controlling the Settlement System and the Receipt System When an Electronic Receipt is Output According to Customer Identification Information

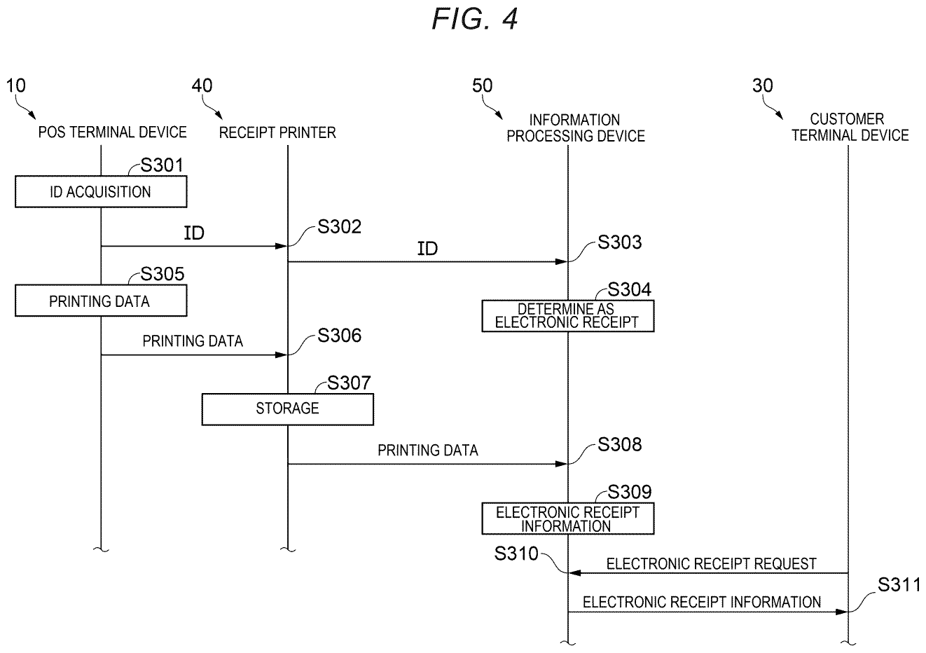

Output of an electronic receipt according to customer identification information is explained with reference to FIG. 4. The customer identification information is, for example, a membership number of the customer in a store. In the following explanation, the customer identification information is referred to as ID. Explanation is omitted about the same contents as “2. Method of controlling the settlement system and the receipt system when an electronic receipt is output” explained above with reference to FIG. 2 and differences are mainly explained.

The first control unit 11 of the POS terminal device 10 reads, with the reader of the first input/output unit 14, information of an IC, a two-dimensional code, or the like carried by the customer terminal device 30 or a card of the customer and acquires an ID of the customer (S301).

The first control unit 11 of the POS terminal device 10 transmits the acquired ID to the receipt printer 40 (S302). The fourth control unit 41 of the receipt printer 40 transmits the ID received from the POS terminal device 10 to the information processing device 50 (S303).

The POS terminal device 10 can register the ID of the customer desiring the electronic receipt in the fifth storage unit 53 of the information processing device 50.

The fifth control unit 51 of the information processing device 50 can check, referring to the fifth storage unit 53, whether the ID received from the receipt printer 40 is registered as an ID to which the electronic receipt should be output.

The fifth control unit 51 of the information processing device 50 refers to the fifth storage unit 53 and, when the ID received from the receipt printer 40 is registered as the ID to which the electronic receipt is output, determines that the form for outputting settlement information to the customer is the electronic receipt (S304).

Subsequently, processing from when the POS terminal device 10 generates the printing data (S305) to when the information processing device 50 receives the printing data (S308) is the same as the case in FIG. 2 explained above. Therefore, explanation of the processing is omitted. The processing from (S305) to (S308) illustrated in FIG. 4 corresponds to the processing from (S101) to (S104) illustrated in FIG. 2.

As explained above, the fifth control unit 51 of the information processing device 50 has already determined that the form of outputting the settlement information to the customer is the electronic receipt (S304).

Therefore, the fifth control unit 51 generates electronic receipt information based on the printing data received from the receipt printer 40 (S309). The electronic receipt information is stored in the fifth storage unit 53.

The third control unit 31 of the customer terminal device 30 generates an electronic receipt request based on predetermined operation on the third input/output unit 33 by the customer and transmits the electronic receipt request to the information processing device 50 (S310).

When receiving the electronic receipt request from the customer terminal device 30, the fifth control unit 51 of the information processing device 50 reads the electronic receipt information from the fifth storage unit 53 and transmits the electronic receipt information to the customer terminal device 30 (S311).

The third control unit 31 of the customer terminal device 30 can display, with the third input/output unit 33, the electronic receipt information received from the information processing device 50.

That is, the information processing device 50 can output the settlement information in the form of the electronic receipt with the customer terminal device 30 based on the ID of the customer received from the POS terminal device 10 through the receipt printer 40.

When receiving the printing data without receiving the ID from the receipt printer 40, the fifth control unit 51 of the information processing device 50 can perform the determination and the processing in the same manner as “2. Method of controlling the settlement system and the receipt system when an electronic receipt is output” and “3. Method of controlling the settlement system and the receipt system when a paper receipt is output” explained with reference to FIGS. 2 and 3.

That is, as explained above, the fifth control unit 51 determines, based on the selection of the customer for the store terminal device 20, whether the output form of the settlement information is the paper receipt or the electronic receipt.

When determining that the output form is the electronic receipt, the fifth control unit 51 can transmit the electronic receipt information to the customer terminal device 30 and cause the customer terminal device 30 to display the electronic receipt information. On the other hand, when determining that the output form is the paper receipt, the fifth control unit 51 can cause the receipt printer 40 to print the paper receipt.

When the ID received from the receipt printer 40 is not registered as an ID to which the electronic receipt is output, similarly, the fifth control unit 51 can perform the determination and the processing of “2. Method of controlling the settlement system and the receipt system when an electronic receipt is output” and “3. Method of controlling the settlement system and the receipt system when a paper receipt is output” explained with reference to FIGS. 2 and 3.

In FIG. 4, the POS terminal device 10 transmits the printing data after transmitting the ID. However, the printing data may be transmitted together with the ID.

In this case, the POS terminal device 10 transmits the printing data to the information processing device 50 through the receipt printer 40 together with the ID. When receiving the printing data together with the ID, first, the fifth control unit 1 of the information processing device 50 can determine, based on the ID, that an output form is an electronic receipt, subsequently, generate electronic receipt information from the printing data, and transmit the electronic receipt information to the customer terminal device 30.

As explained above, the POS system 1 according to the present embodiment includes the receipt printer 40 including the fourth control unit 41, the information processing device 50 including the fifth control unit 51, the POS terminal device 10 including the first control unit 11, the store terminal device 20 including the second control unit 21, and the customer terminal device 30 including the third control unit 31.

In the POS system 1, the first control unit 11 of the POS terminal device 10 generates printing data and transmits the printing data to the receipt printer 40, the fourth control unit 41 of the receipt printer 40 transmits the received printing data to the information processing device 50, and the fifth control unit 51 of the information processing device 50 generates image data based on the received printing data and transmits the image data to the store terminal device 20.

The second control unit 21 of the store terminal device 20 displays the received image data and, when an electronic receipt has been selected, transmits first selection information to the information processing device 50.

The fifth control unit 51 of the information processing device 50 determines, based on the received first selection information, that the electronic receipt has been selected, generates electronic receipt information, and transmits the electronic receipt information when receiving an electronic receipt request from the customer terminal device 30.

With the POS system 1 explained above, when the electronic receipt has been selected by the store terminal device 20, the information processing device 50 can determine that the electronic receipt has been selected and transmit the electronic receipt information to the customer terminal device 30.

The receipt printer 40 includes the printing unit 44. The second control unit 21 of the store terminal device 20 transmits second selection information to the information processing device 50 when not the paper receipt but the electronic receipt has been selected. The fifth control unit 51 of the information processing device 50 determines, based on the received second selection information, that the paper receipt has been selected and transmits a printing request to the receipt printer 40. The fourth control unit 41 of the receipt printer 40 prints the printing data with the printing unit 44 based on the received printing request.

With the POS system 1 explained above, when the paper receipt has been selected by the store terminal device 20, the information processing device 50 can determine that the paper receipt has been selected, transmit a printing request to the receipt printer 40, and cause the receipt printer 40 to print the paper receipt.

In the POS system 1 of the present embodiment, the first control unit 11 of the POS terminal device 10 acquires an ID of the customer and transmits the ID to the receipt printer 40 and the fourth control unit 41 of the receipt printer 40 transmits the received ID to the information processing device 50.

The fifth control unit 51 of the information processing device 50 determines, based on the received ID, that the electronic receipt has been selected. Next, the first control unit 11 of the POS terminal device 10 generates printing data and transmits the printing data to the receipt printer 40. The fourth control unit 41 of the receipt printer 40 transmits the received printing data to the information processing device 50.

By determining that the electronic receipt has been selected, the fifth control unit 51 of the information processing 50 device generates electronic receipt information based on the received printing data and transmits the electronic receipt information when receiving an electronic receipt request from the customer terminal device 30.

With the POS system 1 explained above, when the ID is transmitted from the POS terminal device 10, the information processing device 50 can determine that the electronic receipt has been selected and transmit the electronic receipt information to the customer terminal device 30.

The receipt system 2 in the present embodiment includes the receipt printer 40 including the fourth control unit 41 and the information processing device 50 including the fifth control unit 51.

The receipt printer 40 is capable of communicating with the information processing device 50 and the POS terminal device 10. The information processing device 50 is capable of communicating with the receipt printer 40, the store terminal device 20, and the customer terminal device 30.

In the receipt system 2, the fourth control unit 41 of the receipt printer 40 receives printing data from the POS terminal device 10 and transmits the printing data to the information processing device 50. The fifth control unit 51 of the information processing device 50 generates image data based on the received printing data and transmits the image data to the store terminal device 20. When receiving the first selection information from the store terminal device 20, the fifth control unit 51 of the information processing device 50 determines, based on the first selection information, that the electronic receipt has been selected and generates electronic receipt information and transmits the electronic receipt information when receiving an electronic receipt request from the customer terminal device 30.

With the receipt system 2 explained above, when the electronic receipt has been selected by the store terminal device 20, the information processing device 50 can determine that the electronic receipt has been selected and transmit the electronic receipt information to the customer terminal device 30.

The receipt printer 40 includes the printing unit 44. When receiving the second selection information different from the first selection information from the store terminal device 20, the fifth control unit 51 of the information processing device 50 determines, based on the second selection information, that the paper receipt has been selected and transmits a printing request to the receipt printer 40. The fourth control unit 41 of the receipt printer 40 prints printing data with the printing unit 44 to print the printing data based on the received printing request.

With the receipt system 2 explained above, when the paper receipt has been selected by the store terminal device 20, the information processing device 50 can determine that the paper receipt has been selected, transmit a printing request to the receipt printer 40, and cause the receipt printer 40 to print the paper receipt.

As explained above, the present embodiment is explained in detail with reference to the drawings. However, a specific configuration is not limited to the embodiment and may be, for example, changed, replaced, or deleted without departing from the gist of the present disclosure.

Programs implementing functions of any components in the devices explained above may be recorded in a computer-readable recording medium and the programs may be read and executed by a computer system. The “computer-readable recording medium” includes a portable medium such as a flexible disc, a magneto-optical disc, a ROM, or a CD (compact disk)-ROM, and a storage device such as a hard disk incorporated in a computer system. Further, the “computer-readable recording medium” includes a medium that stores a program for a certain period of time such as a volatile memory inside a computer system serving as a server or a client when the program is transmitted via a network such as the Internet or a communication line such as a telephone line.

The program may be transmitted from a computer system in which the program is stored in a storage device or the like to another computer system via a transmission medium or by a transmission wave in the transmission medium. Here, the “transmission medium” for transmitting the program refers to a medium including a function of transmitting information like a network such as the Internet or a communication line such as a telephone line.

The program may be a program for implementing a part of the functions explained above. Further, the program may be a so-called difference file or differential program that can implement the functions explained above in combination with a program already recorded in the computer system.

What is claimed is:

1. A settlement system comprising:
a receipt printer including a fourth controller;
an information processing device including a fifth controller;
a first terminal device including a first controller;
a second terminal device including a second controller; and
a third terminal device including a third controller, wherein
the first controller of the first terminal device generates printing data and transmits the printing data to the receipt printer,
the fourth controller of the receipt printer transmits the received printing data to the information processing device,
the fifth controller of the information processing device generates image data based on the received printing data and transmits the image data to the second terminal device,
the second controller of the second terminal device displays the received image data and transmits first selection information to the information processing device when an electronic receipt was selected, and
the fifth controller of the information processing device determines, based on the received first selection information, that the electronic receipt was selected and generates electronic receipt information and transmits the electronic receipt information when receiving an electronic receipt request from the third terminal device.

2. The settlement system according to claim 1, wherein
the receipt printer includes a printing unit,
the second controller of the second terminal device transmits second selection information to the information processing device when not the electronic receipt but a paper receipt was selected,
the fifth controller of the information processing device determines, based on the received second selection information, that the paper receipt was selected and transmits a printing request to the receipt printer, and
the fourth controller of the receipt printer prints the printing data with the printing unit based on the received printing request.

3. The settlement system according to claim 1, wherein
when acquiring customer identification information, the first controller of the first terminal device transmits the customer identification information to the receipt printer,
the fourth controller of the receipt printer transmits the received customer identification information to the information processing device,
the fifth controller of the information processing device determines, based on the received customer identification information, that the electronic receipt was selected,
the first controller of the first terminal device generates the printing data and transmits the printing data to the receipt printer,
the fourth controller of the receipt printer transmits the received printing data to the information processing device, and
the fifth controller of the information processing device generates the electronic receipt information based on the received printing data and transmits the electronic receipt information when receiving the electronic receipt request from the third terminal device.

4. A settlement system comprising:
a receipt printer including a fourth controller;
an information processing device including a fifth controller;
a first terminal device including a first controller;
a second terminal device including a second controller; and
a third terminal device including a third controller, wherein
the first controller of the first terminal device acquires customer identification information and transmits the customer identification information to the receipt printer,
the fourth controller of the receipt printer transmits the received customer identification information to the information processing device,
the fifth controller of the information processing device determines, based on the received customer identification information, that an electronic receipt was selected,
the first controller of the first terminal device generates printing data and transmits the printing data to the receipt printer,
the fourth controller of the receipt printer transmits the received printing data to the information processing device, and
the fifth controller of the information processing device generates electronic receipt information based on the received printing data, and transmits the electronic receipt information when receiving an electronic receipt request from the third terminal device.

5. A receipt system comprising:
a receipt printer including a fourth controller; and
an information processing device including a fifth controller, wherein
the receipt printer is capable of communicating with the information processing device and a first terminal device,
the information processing device is capable of communicating with the receipt printer, a second terminal device, and a third terminal device,
the fourth controller of the receipt printer receives printing data from the first terminal device and transmits the printing data to the information processing device, and
the fifth controller of the information processing device generates image data based on the received printing data and transmits the image data to the second terminal device and, when receiving first selection information from the second terminal device, determines, based on the first selection information, that an electronic receipt was selected and generates electronic receipt information and transmits the electronic receipt information when receiving an electronic receipt request from the third terminal device.

6. The receipt system according to claim 5, wherein
the receipt printer includes a printing unit,
when receiving second selection information different from the first selection information from the second terminal device, the fifth controller of the information processing device determines, based on the second selection information, that a paper receipt was selected and transmits a printing request to the receipt printer, and
the fourth controller of the receipt printer prints the printing data with the printing unit based on the received printing request.

7. A method of controlling a receipt system including a receipt printer and an information processing device, wherein
the receipt printer is capable of communicating with the information processing device and a first terminal device,
the information processing device is capable of communicating with the receipt printer, a second terminal device, and a third terminal device,
the receipt printer receives printing data from the first terminal device and transmits the printing data to the information processing device, and
the information processing device generates image data based on the received printing data and transmits the image data to the second terminal device and, when receiving first selection information from the second terminal device, determines, based on the first selection information, that an electronic receipt was selected and generates electronic receipt information and transmits the electronic receipt information when receiving an electronic receipt request from the third terminal device.

8. The method of controlling the receipt system according to claim 7, wherein
when receiving second selection information different from the first selection information from the second terminal device, the information processing device determines, based on the second selection information, that a paper receipt was selected and transmits a printing request to the receipt printer, and
the receipt printer prints the printing data based on the received printing request.
